(19) United States
(12) Patent Application Publication
(10) Pub. No.: US 2016/0138753 A1
(43) Pub. Date: May 19, 2016

(54) DOCUMENT AND ELECTRONIC DEVICE HOLDER

(71) Applicant: Knape & Vogt Manufacturing Company, Grand Rapids, MI (US)

(72) Inventor: Paul V. Crossland, Kitchener (CA)

(21) Appl. No.: 14/885,454

(22) Filed: Oct. 16, 2015

Related U.S. Application Data
(60) Provisional application No. 62/081,937, filed on Nov. 19, 2014.

(51) Int. Cl. F16M 13/02; H04M 1/04; A47B 21/04; F16M 11/10

(52) U.S. Cl. CPC F16M 13/02; F16M 11/10; H04M 1/04; A47B 21/045

(57) ABSTRACT

A document and electronic device holder includes a base, a holder body being pivotally connected to the base, and the holder body further comprising a backrest pivotally connected to a channel. A document and electronic device holder may be used in combination with a keyboard support device, wherein the keyboard support device includes an extendible arm slidably coupled to a track, and the document and electronic device holder includes a base adapted to be mounted to the track of the keyboard support device, a holder body being pivotally connected to the base, and the holder body being foldable from an open position to a closed position.

### CROSS-REFERENCE TO RELATED APPLICATION

This application claims the benefit of U.S. Provisional Patent Application Ser. No. 62/081,937, filed Nov. 19, 2014, the disclosure of which is hereby incorporated by reference in its entirety.

### FIELD OF THE DISCLOSURE

This disclosure is directed to a document and electronic device holder that may be used to hold a document or electronic device upright at a workstation, such as when mounted to the front of a track to which an extendible keyboard support of a keyboard support device is slidably connected, wherein the track, in turn, is mounted to the lower surface of a tabletop or desktop. The holder also may be folded inward upon itself to a closed position, when not in use, to allow maximum upward travel of an adjacent keyboard support device.

### BACKGROUND

Various devices for holding documents have been provided for use at workstations where a user may wish to have available a document while utilizing a data entry device, such as a computer keyboard or mouse. Prior art devices also have been constructed to hold an electronic device in a position for viewing while using such a data entry device.

### SUMMARY

Prior art apparatus have not tended to be structured for use with a variety of items, such as documents and electronic devices, for mounting in a location between a user and a screen at a workstation, or for having an open position for use and a closed position for storage that is raised and compact. Such a raised, compact storage position may be needed when the document and electronic device holder is not in use, for example, to avoid interfering with an extendible keyboard support that may be moved to an uppermost position.

The disclosure provides a document and electronic device holder that may be connected to a work station, and in a preferred embodiment is designed for tool-less attachment to tracks of existing keyboard support devices. The device may be constructed of polypropylene, or other suitable materials, such as by injection molding or other suitable methods of manufacturing. In a preferred embodiment, the device may be configured as a single injection molded piece having three living hinges. The living hinges form a 3 bar linkage or over-center linkage, that has an open position and a closed position.

In the open position, the holder is adapted to hold one or more documents or an electronic device. For instance, the holder may be configured to grip one or more sheets of paper or plastic and to cause a curvature in such items, which will be referred to herein as documents, to introduce some form-based structural rigidity that will tend to make them stand upright, instead of flopping forward or rearward. Alternatively, the holder may hold an electronic device, such as a tablet computer or cellular telephone, in an upright position for viewing. In a preferred embodiment, the holder includes an aperture to expose a port on the electronic device that will permit the electronic device to be plugged into a charging cord, or other electronic apparatus.

The linkage structure also allows the holder to be folded inward upon itself to a closed position, when not in use. In the closed position, the holder provides increased clearance for an extendible keyboard support of a keyboard support device that may be moved to its uppermost position.

In a preferred embodiment, a mounting flange extends from the holder and is used to connect the holder to the front cap of a track of a keyboard support device. For ease of use, the mounting flange preferably may be configured to permit tool-less mounting.

The holder of the preferred embodiment provides several advantages over separate, standalone document or standalone electronic device holders including: being of low cost; low complexity for construction; a single material; the flange having an adjustable depth to accommodate for variations in the mounting of the track relative to the front edge of a desk or table; the holder occupies an existing space not otherwise used; the holder folds into itself to provide increased clearance when not in use; the holder can hold documents or electronic devices; and in the preferred configuration the holder is able to be used with existing keyboard support devices that have a track having a suitable opening, although the mounting flange or track could be of a different design, if necessary, to permit an alternative mounting configuration.

In a first aspect, the present disclosure provides a document and electronic device holder that includes a base, a holder body being pivotally connected to the base, and the holder body further comprising a backrest pivotally connected to a channel.

In a second aspect, the present disclosure provides a document and electronic device holder that includes a base adapted to be mounted to a track of a keyboard support device, a holder body being pivotally connected to the base, and the holder body being foldable from an open position to a closed position.

In a third aspect, the present disclosure provides a document and electronic device holder in combination with a keyboard support device where the keyboard support device has an extendible keyboard support slidably coupled to a track, and a document and electronic device holder that includes a base adapted to be mounted to the track of the keyboard support device, a holder body being pivotally connected to the base, and the holder body being foldable from an open position to a closed position.

The disclosure provides a preferred embodiment, as but one example of a configuration of a document and electronic device holder that provides a compact design having a base that may be connected to a workstation and that is able to pivot from an open position for use in supporting one or more documents or an electronic device to a closed position to be stowed in a compact, raised storage position. It will be appreciated that with the present example, the mounting to a workstation may be to a track of a keyboard support device, such as by insertion of a mounting flange into an aperture in a front cap of the track. Indeed, the preferred embodiment utilizes a tool-less mounting arrangement that permits adjustments inward or outward relative to a workstation. Alternatively, the mounting may be by direct connection to other components of the workstation, whether to the desk or table, or to another portion of a keyboard support device.

The present disclosure provides a document and electronic device holder that allows inline mounting between a keyboard and a monitor. This facilitates convenient viewing of a document or electronic device while operating the keyboard or another input device, such as a mouse. The unique structure has an open position in which it provides support for a variety of items, with access for an electrical connection, if needed, while also having a closed position in which it may be pivoted upward and inward relative to itself to a stowed position that allows a keyboard support to be raised to an uppermost position.

These and other objects, advantages, and features of the disclosure will be set forth in the detailed description which follows.

### BRIEF DESCRIPTION OF THE DRAWINGS

In describing the preferred examples, references are made to the accompanying drawing figures wherein like parts have like reference numerals, and wherein:

FIG. 1 is front upper perspective view of an example embodiment of a document and electronic device holder shown in the open position.

FIG. 2 is a rear upper perspective view of the example document and electronic device holder shown in FIG. 1.

FIG. 3 is a top view of the example document and electronic device holder shown in FIG. 1.

FIG. 4 is a front upper perspective exploded view of the example document and electronic device holder of FIG. 1 located forward of a workstation and an aperture in a front cap of a track of a keyboard support device.

FIG. 5 is a front upper perspective exploded view of the example document and electronic device holder of FIG. 1 showing the engagement of the device with the front cap of the track of FIG. 4.

FIG. 6 is a front perspective view of the example document and electronic device holder of FIG. 1 shown in an open position and holding a document above a keyboard support device, while the keyboard work surface is not shown for reasons of clarity.

FIG. 7 is a front perspective view of the example document and electronic device holder of FIG. 1 shown in an open position and holding an electronic device in the form of a tablet computer above a keyboard support device, while the keyboard work surface is not shown for reasons of clarity.

FIG. 8 is a front perspective view of the example document and electronic device holder of FIG. 1 shown in an open position and holding an electronic device in the form of a cellular telephone above a keyboard support device, while the keyboard work surface is not shown for reasons of clarity.

FIG. 9 is a side view of the example document and electronic device holder of FIG. 1 shown in an open position and holding an electronic device in the form of a tablet computer while connected to a front cap of a track of a keyboard support device above an arm of the keyboard support device, and further including a non-slip pad at the rear of the electronic device.

FIG. 10 is a side view of the example document and electronic device holder of FIG. 9 shown in a closed position, folded upward while connected to a front cap of a track of a keyboard support device.

It should be understood that the drawings are not necessarily to scale. While some mechanical details relating to document and electronic device holders, including some details of alternative fastening or connecting means and other plan and section views have been omitted, such details are considered within the comprehension of those skilled in the art in light of the present disclosure. It also should be understood that the present disclosure is not limited to the example illustrated.

### DETAILED DESCRIPTION

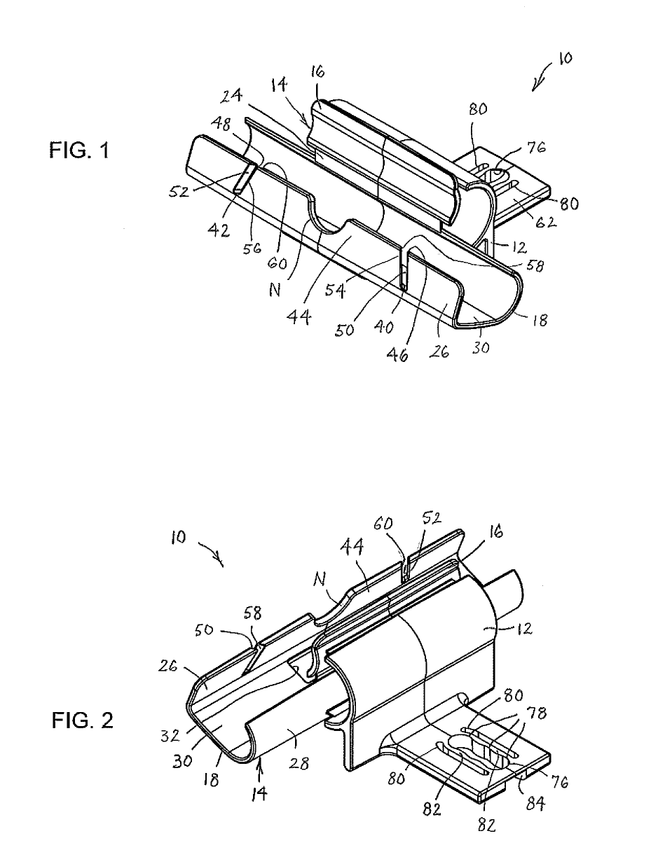

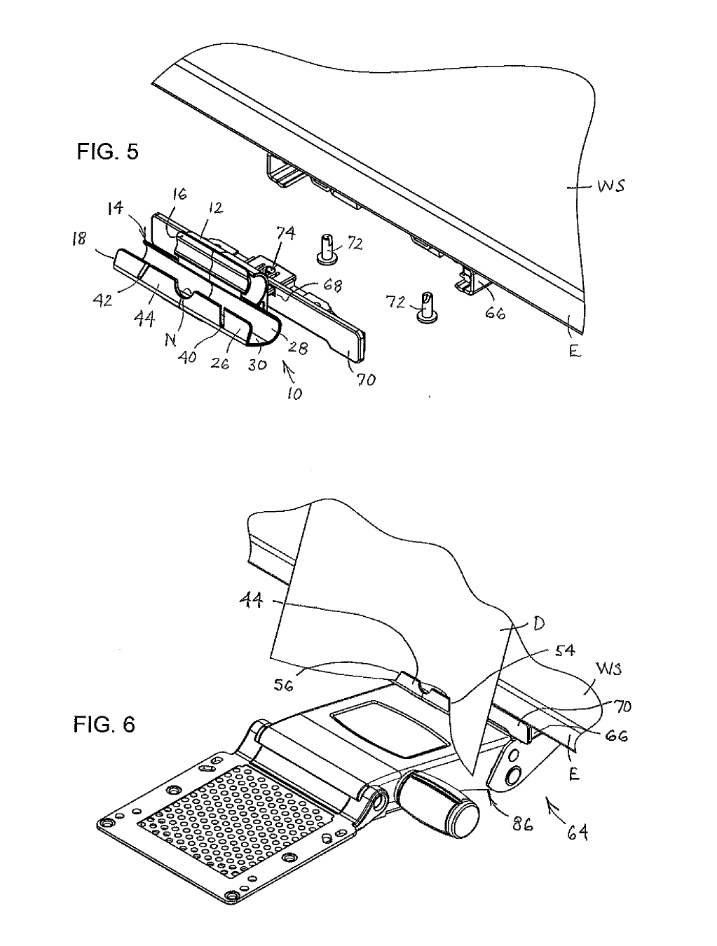

This disclosure presents examples of apparatus and methods of using the same, which may be embodied in several forms. For instance, within FIGS. 1-10 a preferred example document and electronic device holder is shown, alone and in combination with a keyboard support device, as will be described further herein. It will be appreciated, however, that the invention may be constructed and configured in various ways and is not limited to the example disclosed in the form of the preferred embodiment shown and described herein.

An example embodiment of a document and electronic device holder 10 is shown in several perspective and side views within FIGS. 1-10. The document and electronic device holder 10, hereinafter referred to as holder 10, includes a base 12, a holder body 14 that is pivotally connected to the base 12, with the holder body 14 further including a backrest 16 pivotally connected to a channel 18. In this example, the holder body 14 is pivotally connected to the base 12 at two spaced apart locations, namely, at hinges 20 and 22, while the backrest 16 is pivotally connected to the channel 18 at hinge 24. In this example, the hinges 20, 22, 24 preferably are integral hinges that are formed with the holder 10, which may be formed in a single piece. For instance, the single piece may be constructed of plastic, such as of injection molded polypropylene, or other suitable materials. The holder could, however, have separately constructed hinges and components connected to each other by suitable means, such as by use of adhesives or fasteners.

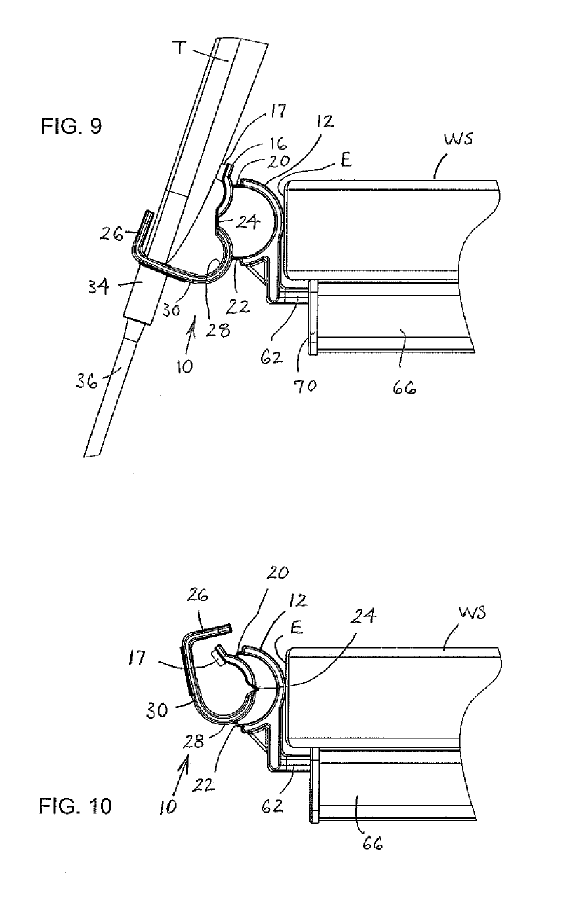

It will be appreciated that this configuration of the holder 10 provides a three bar linkage wherein the pivotal connection of the backrest 16 to the channel 18 at hinge 24 is disposed between the two spaced apart locations of the pivotal connections between the holder body 14 and the base 12 at hinges 20, 22. The three bar linkage, in turn, is formed by non-linear portions of the base 12, the backrest 16 and the channel 18. The three bar linkage creates an over center pivot lock mechanism, enabling it to hold its folded position. This structure permits the holder body 14 of the holder 10 to be pivotally movable from an open position for use in holding one or more documents or an electronic device, as may be seen in FIGS. 6-9, to a closed position to be stowed in a compact configuration upward and out of the way of a keyboard support arm of a keyboard support device, as shown in FIG. 10.

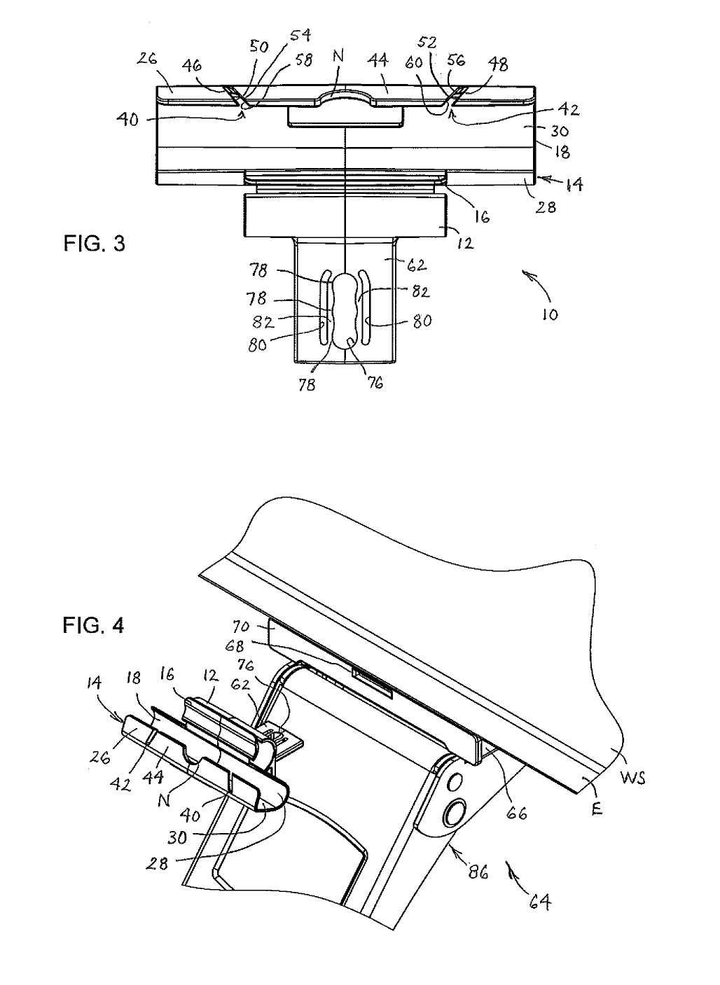

The channel 18 includes an upstanding forward wall 26 and an upstanding rearward wall 28 that are connected to a bottom wall 30. The bottom wall 30 of the channel 18 also may include an aperture 32, as may be seen in FIGS. 2 and 3. The aperture 32 permits access to a port in the bottom of an electronic device T that is being supported by the holder 10 and provides the convenience of allowing an electrical connector 34 and a cord 36 extending from the electrical connector 34, such as is shown in FIG. 9, to pass through the holder 10 if the electronic device is lifted while the electronic device T is still connected to the electrical connector 34.

The upstanding forward wall 26 includes at least two slots 40 and 42, with the two slots 40, 42 being spaced apart along a length of the upstanding forward wall 26. The two slots 40, 42 also define therebetween a middle segment 44 of the upstanding forward wall 26. To induce a curvature in one or more documents D that may be held by the holder 10, the outermost edges 46, 48 of the two slots 40, 42 have angled surfaces 50, 52 that generally face toward one another, while the middle segment 44 of the upstanding forward wall 26 has outermost edges 54, 56 that form the innermost edges of the respective slots 40, 42 and that further comprise angled surfaces 58, 60 that generally face away from each other and that are substantially parallel to the angled surfaces 50, 52 on the outermost edges 46, 48 of the two slots 40, 42.

It will be appreciated that when one or more documents D are held within the two slots 40, 42 of the upstanding forward wall 26, as represented in FIG. 6, the one or more documents D will have a curvature induced by the path at their lower end through the slots 40, 42 and behind the middle segment 44. The transition through the slots 40, 42 is eased somewhat, such as to avoid creasing the documents D, by the complementary angled surfaces 50, 52 at the outer most edges 46, 48 of the two slots 40, 42 and the angled surfaces 58, 60 at the outermost edges 54, 56 of the middle segment 44 of the upstanding forward wall 26. In the preferred example shown, the angle of the angled surfaces 50,52, 58, 60 relative to the forward and rearward faces of the upstanding forward wall 26 is approximately 45 degrees, although it will be appreciated that other angles may be chosen. Thus, when properly engaged in the holder 10, one or more documents D will slide downward into slots 40, 42 and pass behind the middle segment 44, which will generate a vertically extending curvature that will tend to prevent the one or more documents D from flopping forward or rearward, and the one or more documents D will be able to lean rearward against the backrest 16 to help support them in an upstanding position for easy viewing by a user. The curvature of the one or more documents may tend to be reduced as one moves from the bottom to the top of the documents, depending on the relative positioning and configuration of the two slots 40, 42. As disclosed, the holder 10 may retain documents of various heights, widths and thicknesses, within an inline position between a keyboard that may be positioned on the keyboard support device 64 and a monitor that may be positioned on the work surface WS of the work station.

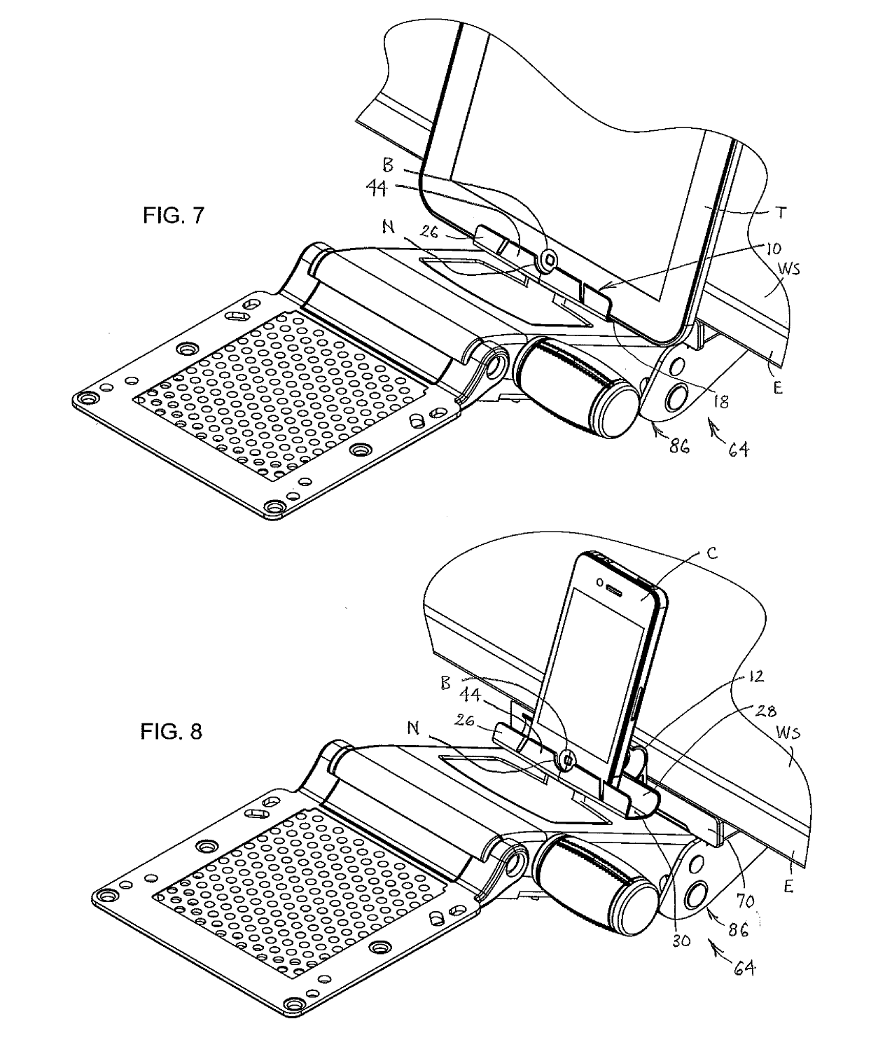

The holder 10 alternatively may be used to support electronic devices, as shown for instance in FIGS. 7-9. FIGS. 7 and 9 depict a holder 10 supporting a tablet type computer T. It will be appreciated that the upstanding forward wall 26 of the channel 18 may include an arcuate notch N or various notches or apertures to permit access to a button B or other buttons, ports or other features on the front of an electronic device. As may be seen in FIG. 9, the bottom of the tablet type computer T rests on the bottom wall 30 of the channel 18 and is held between the upstanding forward wall 26 and the upstanding rearward wall 28. The tablet type computer T also may lean rearward and be supported by the backrest 16. The backrest 16 may include a pad 17 that would contact the rear surface of an electronic device, such as is shown in FIGS. 9 and 10. The pad may have a non-slip front surface, such as a silicone grip, to inhibit movement of an electronic device that has been placed in the channel 18, and may be connected to the backrest 16 by use of adhesive, fasteners or other suitable means of attachment. As noted previously, the aperture 32 in the bottom wall 30 of the channel 18 permits an electrical connector 34 to pass through the holder 10 and be connected to a port in the bottom of the tablet type computer T.

Similarly, FIG. 8 depicts a holder 10 supporting a cellular telephone C. The notch N in the upstanding forward wall 26 of the channel 18 permits access to a button B. As with FIG. 9, the bottom of the cellular telephone C would rest on the bottom wall 30 of the channel 18 and be held between the upstanding forward wall 26 and the upstanding rearward wall 28. The cellular telephone C also may lean rearward and be supported by the backrest 16. Also, the aperture 32 in the bottom wall 30 of the channel 18 of the holder 10 permits access for connection of a port in the bottom of the cellular telephone C to an electrical connector, such as the electrical connector 34 that is shown in FIG. 9. The aperture 32 further permits a user to lift an electronic device from the holder 10 to manipulate a feature on the electronic device or to temporarily hold it closer to the user, if needed, while the electrical connector 34 and cord 36 connected thereto simply extend through the aperture 32, without needing to be disconnected. It should be noted that, in FIGS. 7 and 8 the electronic devices, T and C, also may rest in a landscape orientation that is rotated 90 degrees from the positions shown.

It will be appreciated that the document and electronic device holder 10 may be connected to a workstation in a variety of ways, such as by use of fasteners, although a preferred structure and method of connection are shown in the example embodiment. In this example, a mounting flange 62 extends rearward from the base 12 and is adapted to be connected to a keyboard support device 64. The mounting flange 62 is shown in a configuration that is adapted to be connected to a track 66 of a keyboard support device 64. A tool-less connection may be had in this preferred example wherein the mounting flange 62 is adapted to be insertable into an aperture 68 in a front cap 70 of the track 66 of a keyboard support device 64. The front cap 70 may be connected to the track 66, such as by use of fasteners 72 in the form of screws or rivets. In this example, the front cap 70 also includes an upstanding projection or post 74 that fits within a slot 76 in the mounting flange 62. The slot 76 includes three wider regions 78 along its length, and additional slots 80, which are spaced outward from the slot 76, result in the slot 76 having flexible side walls 82. A flared entry to a groove 84 at the rear of the mounting flange 62 and the wider regions 78 of the slot 76 and flexible side walls 82 permit the mounting flange 62 to be inserted into the aperture 68 and retained by the projection or post 74 at different depths of insertion. In this manner, the mounting flange 62 may accommodate different setback positions of a track 66 of a keyboard support device 64 relative to a front edge E of a work surface, such as a desk top or table top, to which the track 66 may be mounted.

As will be appreciated, the document and electronic device holder 10 may be provided in combination with a keyboard support device 64, in which case the combination may include a keyboard support device 64 having an extendible keyboard support 86 slidably coupled to a track 66, and a document and electronic device holder 10, such as of the type previously described, having a base 12 adapted to be mounted to the track 66 of the keyboard support device 64, a holder body 14 being pivotally connected to the base 12, and the holder body 14 being foldable from an open position, as shown in FIGS. 6-9, to a closed position to be stowed, as shown in FIG. 10. When not in use, the tool-less mounting provided by the preferred example also permits the holder 10 to be quickly and conveniently removed by withdrawing the mounting flange 62 from the aperture 68 in the front cap 70 of the track 66. In this manner, the combination may be mounted to a workstation, such as a desktop or tabletop. Also, it will be appreciated that the keyboard support device may be constructed of various materials that are well known in the art and suitable for their intended purposes.

With the example shown and described above, the document and electronic device holder 10 may be adjusted to be in an open position for use, as shown in FIGS. 6-9, or in a closed position for stowage, in a compact, raised location in front of the front edge E of a workstation. The three hinges 20, 22, 24, and three bar linkage aspect of the holder 10 provide for over-center travel that allows the holder 10 to fold inward on itself and be releasably held in the closed position. As the channel 18 would be rotated forward and downward, the hinges 20, 22, 24 would cause the holder 10 to be unfolded and moved to the open position for use. This provides a very cost effective device in that it may be formed as a single piece having integral hinges, otherwise referred to as living hinges.

It will be appreciated that the disclosed example described presents numerous potential features for a document and electronic device holder that may be used in combination with a keyboard support device. Thus, while the present disclosure shows and describes a preferred example of the holder, keyboard support device, and various types of items that may be supported by the holder, the examples are merely illustrative and are not to be considered limiting. Indeed, it will be apparent to those of ordinary skill in the art that various document and electronic device holders may be constructed and configured for use in supporting one or documents or electronic devices, without departing from the scope or spirit of the present disclosure. Thus, although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

I claim:

1. A document and electronic device holder comprising:
a base;
a holder body being pivotally connected to the base; and
the holder body further comprising a backrest pivotally connected to a channel.

2. The document and electronic device holder of claim 1, wherein the holder body is pivotally connected to the base at two spaced apart locations.

3. The document and electronic device holder of claim 2, wherein each of the two spaced apart locations of a pivotal connection of the holder body to the base further comprises an integral hinge.

4. The document and electronic device holder of claim 2, further comprising a three bar linkage wherein the pivotal connection of the backrest to the channel is disposed between the two spaced apart locations of the pivotal connections between the holder body and the base.

5. The document and electronic device holder of claim 4, wherein the three bar linkage is formed by non-linear portions of the base, the backrest and the channel.

6. The document and electronic device holder of claim 1, wherein the pivotal connection of the backrest to the channel further comprises an integral hinge.

7. The document and electronic device holder of claim 1, wherein the holder body is pivotally movable from an open position to a closed position.

8. The document and electronic device holder of claim 1, wherein the document and electronic device holder is constructed of a single continuous piece of plastic.

9. The document and electronic device holder of claim 1, wherein the base further comprises a mounting flange that is adapted to be connected to a keyboard support device.

10. The document and electronic device holder of claim 9, wherein the mounting flange is adapted to be insertable into an aperture in a front cap of a track of the keyboard support device.

11. The document and electronic device holder of claim 1, wherein the channel further comprises a bottom wall having an aperture.

12. The document and electronic device holder of claim 1, wherein the channel further comprises an upstanding forward wall having at least two slots.

13. A document and electronic device holder comprising:
a base adapted to be mounted to a track of a keyboard support device;
a holder body being pivotally connected to the base; and
the holder body being foldable from an open position to a closed position.

14. The document and electronic device holder of claim 13, wherein the holder body is pivotally connected to the base at two locations.

15. The document and electronic device holder of claim 13, wherein the holder body further comprises a backrest pivotally connected to a channel.

16. A document and electronic device holder in combination with a keyboard support device comprising:
a keyboard support device comprising an extendible keyboard support slidably coupled to a track; and
a document and electronic device holder comprising a base adapted to be mounted to the track of the keyboard support device, a holder body being pivotally connected to the base, and the holder body being foldable from an open position to a closed position.

17. The document and electronic device holder in combination with a keyboard support device of claim 16, wherein the track further comprises a front cap and the base further comprises a mounting flange that is adapted to be connected to the front cap.

18. The document and electronic device holder in combination with a keyboard support device of claim 17, wherein the front cap further comprises an aperture and the mounting flange is insertable into the aperture.

19. The document and electronic device holder in combination with a keyboard support device of claim 16, wherein the holder body is pivotally connected to the base at two locations.

20. The document and electronic device holder in combination with a keyboard support device of claim 16, wherein the holder body further comprises a backrest pivotally connected to a channel, and the device further comprises a three bar linkage wherein the pivotal connection of the backrest to the channel is disposed between pivotal connections of the backrest to the base and of the channel to the base.
